(19) United States
(12) Patent Application Publication
(10) Pub. No.: US 2007/0152917 A1
(43) Pub. Date: Jul. 5, 2007

(54) Plasma display apparatus

(75) Inventor: Seonghak Moon, Seoul (KR)

Correspondence Address: KED & ASSOCIATES, LLP, P.O. Box 221200, Chantilly, VA, 20153-1200, US

(73) Assignee: LG Electronics Inc.

(21) Appl. No.: 11/647,470

(22) Filed: Dec. 29, 2006

(30) Foreign Application Priority Data
Dec. 30, 2005 (KR) 10-2005-0135318
Jan. 5, 2006 (KR) 10-2006-0001436

(51) Int. Cl. G09G 3/28

(52) U.S. Cl. 345/67

(57) ABSTRACT

A plasma display apparatus is disclosed. The plasma display apparatus includes a plasma display panel including a scan electrode, a sustain electrode, and an address electrode, and a driver. The driver supplies a first data pulse of either a high level or a low level to the address electrode during a first period. The driver supplies a second data pulse of either a high level or a low level to the address electrode during a second period. The level of the first data pulse is different from the level of the second data pulse.

This Nonprovisional application claims priority under 35 U.S.C. § 119(a) on Patent Application Nos. 10-2005-0135318 and 10-2006-0001436 filed in Korea on Dec. 30, 2005 and Jan. 5, 2006 the entire contents of which are hereby incorporated by reference.

### BACKGROUND

1. Field

This document relates to a plasma display apparatus.

2. Description of the Related Art

A plasma display apparatus includes a plasma display panel including a plurality of electrodes and a driver driving the electrodes of the plasma display panel.

The plasma display panel has the structure in which barrier ribs formed between a front panel and a rear panel forms unit discharge cell or discharge cells. Each of the discharge cell is filled with an inert gas containing a main discharge gas such as neon (Ne), helium (He) and a mixture of Ne and He, and a small amount of xenon (Xe). The plurality of discharge cells form a plurality of pixels for displaying an image. For example, a red (R) discharge cell, a green (G) discharge cell, and a blue (B) discharge cell form one pixel.

When the plasma display panel is discharged by a high frequency voltage, the inert gas generates vacuum ultraviolet rays, which thereby cause phosphors formed between the barrier ribs to emit light, and thus displaying an image.

A driving voltage supplied to the plasma display panel generates a reset discharge during a reset period, an address discharge during an address period, and a sustain discharge during a sustain period, and thus displaying an image.

### SUMMARY

In one aspect, a plasma display apparatus comprises a plasma display panel including a scan electrode, a sustain electrode, and an address electrode, and a driver that supplies a first data pulse of either a high level or a low level to the address electrode during a first period, and supplies a second data pulse of either a high level or a low level to the address electrode during a second period, wherein the level of the first data pulse is different from the level of the second data pulse.

The driver may supply a pulse for erasing wall charges formed on the scan electrode and the sustain electrode to at least one of the scan electrode, the sustain electrode, or the address electrode.

The plasma display apparatus may further comprise a controller controlling the driver to supply the first data pulse and the second data pulse when receiving an image sticking removal mode signal.

The controller may receive the image sticking removal mode signal from a remote controller or a key signal generator.

The first period may be equal to an n-th frame, and the second period may be equal to an (n+1)th frame.

The first period may be equal to an n-th subfield, and the second period may be equal to an (n+1)th subfield.

The driver may supply the first data pulse to emit light from all discharge cells of the plasma display panel, and the driver may supply the second data pulse not to emit light from all the discharge cells of the plasma display panel.

The plasma display panel may include first and second scan electrodes adjacent to each other, a first discharge cell corresponding to the first scan electrode, and a second discharge cell corresponding to the second scan electrode. The driver may supply the first data pulse to emit light from the first discharge cell and not to emit light from the second discharge cell, and the driver may supply the second data pulse not to emit light from the first discharge cell and to emit light from the second discharge cell.

When a variation between an average picture level (APL) of a first frame and an APL of a second frame is more than a threshold value, the driver may supply the first data pulse to the address electrode during the first period, and may supply the second data pulse reverse to the first data pulse to the address electrode during the second period.

When the same image is displayed on the plasma display panel for a predetermined period of time, the driver may supply the first data pulse to the address electrode during the first period, and may supply the second data pulse reverse to the first data pulse to the address electrode during the second period.

In another aspect, a plasma display apparatus comprises a plasma display panel including a scan electrode, a sustain electrode, and an address electrode, a controller that receives an image sticking removal mode signal, and a driver that supplies a pulse for erasing wall charges formed on the scan electrode and the sustain electrode to at least one of the scan electrode, the sustain electrode, or the address electrode when the image sticking removal mode signal is input.

The plasma display apparatus may further comprise at least one of a remote controller or a key signal generator that outputs the image sticking removal mode signal to the controller.

The driver may supply a last sustain pulse of a first polarity to the scan electrode during a sustain period. The driver may supply a first pulse of a second polarity different from the first polarity and a second pulse of the first polarity to the scan electrode and the address electrode during the sustain period, respectively.

A width of the last sustain pulse may be more than a width of the first pulse and a width of the second pulse.

The driver may supply a last sustain pulse of a first polarity to the scan electrode during a sustain period. The driver may supply a first pulse of a second polarity different from the first polarity and a second pulse of the first polarity to the scan electrode and the sustain electrode during the sustain period, respectively.

A width of the last sustain pulse may be more than a width of the first pulse and a width of the second pulse.

The driver may supply a last sustain pulse of a first polarity to the scan electrode during a sustain period. The driver may supply a first pulse of a second polarity different from the first polarity and a second pulse of the first polarity to the sustain electrode and the scan electrode during the sustain period, respectively.

A width of the last sustain pulse may be more than a width of the first pulse and a width of the second pulse.

The driver may supply a last sustain pulse of a first polarity to the scan electrode during a sustain period. The driver may supply a pulse gradually falling from a voltage of the first polarity to a voltage of a second polarity different from the first polarity to the sustain electrode during the sustain period.

The driver may supply a setup pulse with a rising slope, that is less than a rising slope of a setup pulse supplied during a reset period of a subfield, during a reset period of a next subfield, wherein the image sticking removal mode signal is input during the subfield.

The driver may supply a setup pulse with the highest voltage, that is lower than the highest voltage of a setup pulse supplied during a reset period of a subfield, during a reset period of a next subfield, wherein the image sticking removal mode signal is input during the subfield.

The driver may supply reset pulses, that is more than the number of reset pulses supplied during a reset period of a subfield, during a reset period of a next subfield, wherein the image sticking removal mode signal is input during the subfield.

### BRIEF DESCRIPTION OF THE DRAWINGS

The accompany drawings, which are included to provide a further understanding of the invention and are incorporated on and constitute a part of this specification, illustrate embodiments of the invention and together with the description serve to explain the principles of the invention.

FIG. 1 illustrates a plasma display apparatus according to one embodiment;

FIG. 2 illustrates an image displayed by the plasma display apparatus according to one embodiment in each frame;

FIG. 3 illustrates an image displayed by the plasma display apparatus according to one embodiment in each subfield;

FIG. 4 illustrates a strip image displayed by the plasma display apparatus according to one embodiment;

FIG. 5 illustrates a display of on-screen display (OSD) data for removing image sticking;

FIG. 6 illustrates an image sticking removal operation of the plasma display apparatus according to one embodiment depending on an average picture level (APL);

FIG. 7 illustrates an image sticking removal operation of the plasma display apparatus according to one embodiment depending on an image;

FIG. 8a illustrates a first example of a driving pulse of the plasma display apparatus according to one embodiment;

FIG. 8b illustrates a second example of a driving pulse of the plasma display apparatus according to one embodiment;

FIG. 8c illustrates a third example of a driving pulse of the plasma display apparatus according to one embodiment;

FIG. 8d illustrates a fourth example of a driving pulse of the plasma display apparatus according to one embodiment;

FIG. 9a illustrates a fifth example of a driving pulse of the plasma display apparatus according to one embodiment;

FIG. 9b illustrates a sixth example of a driving pulse of the plasma display apparatus according to one embodiment; and

FIG. 9c illustrates a seventh example of a driving pulse of the plasma display apparatus according to one embodiment.

### DETAILED DESCRIPTION OF EMBODIMENTS

Reference will now be made in detail embodiments of the invention examples of which are illustrated in the accompanying drawings.

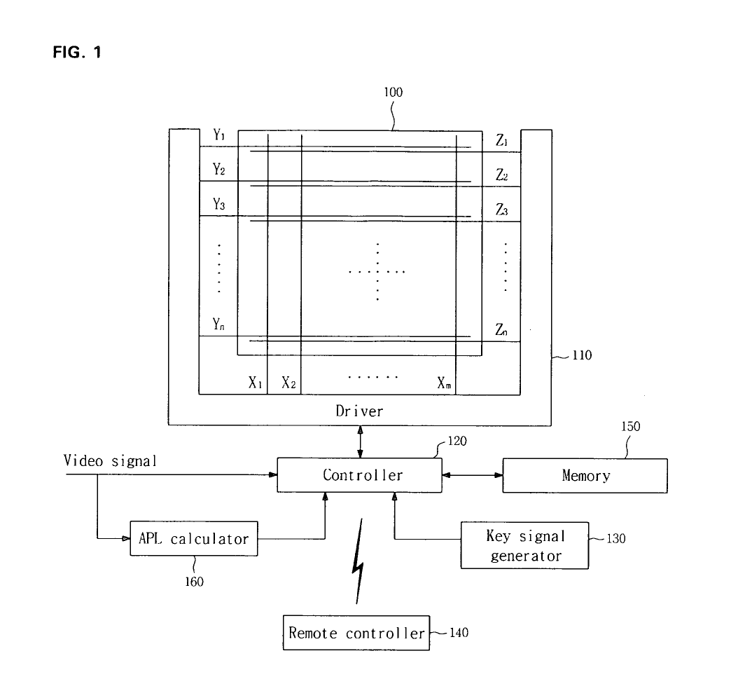

A plasma display apparatus according one embodiment illustrated in FIG. 1 includes a plasma display panel 100, a driver 110, a controller 120, a key signal generator 130, a remote controller 140, a memory 150, and an average picture level (APL) calculator 160.

The plasma display panel 100 includes a plurality of scan electrodes Y1-Yn, a plurality of sustain electrodes Z1-Zn, and a plurality of address electrodes X1-Xm. The plurality of address electrodes X1-Xm are disposed to intersect the plurality of scan electrodes Y1-Yn and the plurality of sustain electrodes Z1-Zn.

The driver 110 supplies a reset pulse for uniformalizing wall charges of the plasma display panel 100 during a reset period, a scan pulse for selecting a discharge cell where light will be emitted, during an address period, and a sustain pulse emitting light from the selected discharge cell during a sustain period to the plurality of scan electrodes Y1-Yn.

The driver 110 supplies a data pulse synchronized with the scan pulse to the address electrodes X1-Xm during the address period. As the scan pulse and the data pulse of a high level are supplied, when the sustain pulse is supplied, light is emitted from the discharge cell selected during the address period. The driver 110 supplies a first data pulse of either a high level or a low level to the address electrodes X1-Xm during a first period. The driver 110 supplies a second data pulse of either a high level or a low level to the address electrodes X1-Xm during a second period, wherein the level of the first data pulse is different from the level of the second data pulse.

The driver 110 supplies a sustain pulse to the sustain electrodes Z1-Zn, thereby emitting light from the discharge cell selected during the address period.

The driver 110 supplies an pulse for erasing wall charges formed on the scan electrodes Y1-Yn and the sustain electrodes Z1-Zn to at least one of the scan electrodes Y1-Yn, the sustain electrodes Z1-Zn, or the address electrodes X1-Xm.

The controller 120 performs an inverse gamma correction proves, a gain control process, a half toning process, a subfield mapping process, and a subfield rearrangement process on video data input from the outside. The controller 120 outputs the video data to the driver 110. The driver 110 supplies a data pulse corresponding to the video data. The controller 120 controls supply timing of various driving pulses supplied by the driver 110.

The controller 120 receives an image sticking removal mode signal, and controls the driver 110 to supply a driving pulse for removing image sticking. In particular, the controller 120 receives the image sticking removal mode signal, and controls the driver 110 to supply the first data pulse and the second data pulse. Operations of the driver 110 and the controller 120 will be described in detail later.

The key signal generator 130 includes a key pad, and outputs the image sticking removal mode signal by an operation of a user.

The remote controller 140 outputs an image sticking removal mode signal of an infrared type by an operation of the user.

The memory 150 stores image sticking removal algorism. After the controller 120 receives the image sticking removal mode signal, the image sticking removal algorism is performed. When the controller 120 starts to control an image sticking removal operation, the controller 120 controls the driver 110 such that an output of normal image data is cut off.

The APL calculator 160 calculates an APL corresponding to each frame. The APL of each of the frame is equal to a ratio of a sum of a gray level corresponding to each of effective discharge cells to the total number of effective discharge cells of the plasma display panel 100. The effective discharge cell means a discharge cell where light is emitted.

The first period during which the first data pulse is supplied and the second period during which the second data pulse is supplied may be one or more frames, or at least one of a plurality of subfields constituting a frame.

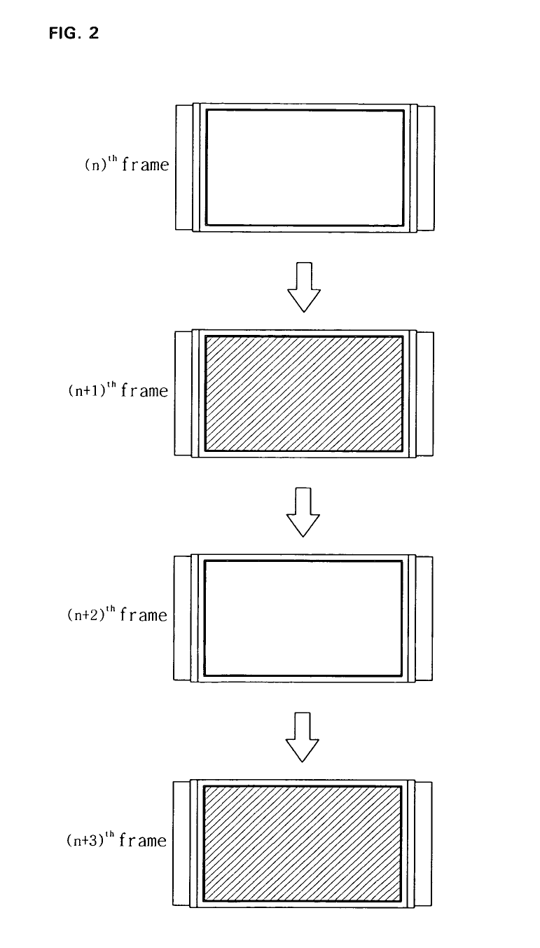

For example, as illustrated in FIG. 2, when the driver 110 supplies a data pulse of a high level to the address electrodes X1-Xm in an nth frame and an (n+2)th frame, an address discharge occurs in all the discharge cells of the plasma display panel 100. Further, when the driver 110 supplies a data pulse of a low level to the address electrodes X1-Xm in an (n+1)th frame and an (n+3)th frame, an address discharge does not occurs in all the discharge cells of the plasma display panel 100. Accordingly, the plasma display apparatus according to one embodiment displays a white image during the nth and (n+2)th frames, and displays a black image during the (n+1)th and (n+3)th frames.

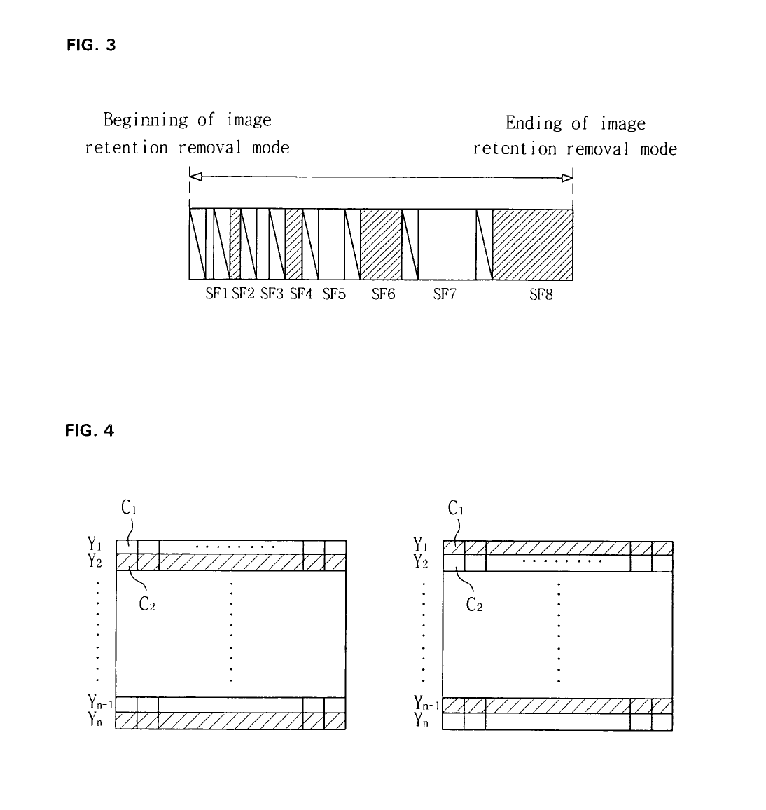

As illustrated in FIG. 3, one frame includes 8 subfields SF1-SF8. When the driver 110 supplies a data pulse of a high level to the address electrodes X1-Xm in the odd-numbered subfields SF1, SF3, SF5, and SF7, an address discharge occurs in all the discharge cells of the plasma display panel 100. Further, when the driver 110 supplies a data pulse of a low level to the address electrodes X1-Xm in the even-numbered subfields SF2, SF4, SF6, and SF8, an address discharge occurs in all the discharge cells of the plasma display panel 100. Accordingly, the plasma display apparatus according to one embodiment displays a white image during the odd-numbered subfields SF1, SF3, SF5, and SF7, and displays a black image during the even-numbered subfields SF2, SF4, SF6, and SF8.

As illustrated in FIG. 4, the plasma display panel 100 includes first and second scan electrodes adjacent to each other, a first discharge cell C1 corresponding to the first scan electrode, and a second discharge cell C2 corresponding to the second scan electrode. The driver 110 supplies the first data pulse to emit light from the first discharge cell C1 and not to emit light from the second discharge cell C2. The driver 110 supplies the second data pulse not to emit light from the first discharge cell C1 and to emit light from the second discharge cell C2.

For example, when the driver 110 supplies a scan pulse to the odd-numbered scan electrodes Y1, Y3, . . . , and Yn−1 in the nth frame, the driver 110 supplies a data pulse of a high level to the address electrodes X1-Xm. When the driver 110 supplies a scan pulse to the even-numbered scan electrodes Y2, Y4, . . . , and Yn in the nth frame, the driver 110 supplies a data pulse of a low level to the address electrodes X1-Xm. Accordingly, light is emitted from the discharge cells corresponding to the odd-numbered scan electrodes Y1, Y3, . . . , and Yn−1, and light is not emitted from the discharge cells corresponding to the even-numbered scan electrodes Y2, Y4, . . . , and Yn.

Further, when the driver 110 supplies a scan pulse to the odd-numbered scan electrodes Y1, Y3, . . . , and Yn−1 in the (n+1)th frame, the driver 110 supplies a data pulse of a low level to the address electrodes X1-Xm. When the driver 110 supplies a scan pulse to the even-numbered scan electrodes Y2, Y4, . . . , and Yn in the (n+1)th frame, the driver 110 supplies a data pulse of a high level to the address electrodes X1-Xm. Accordingly, light is not emitted from the discharge cells corresponding to the odd-numbered scan electrodes Y1, Y3, . . . , and Yn−1, and light is emitted from the discharge cells corresponding to the even-numbered scan electrodes Y2, Y4, . . . , and Yn.

Since a phosphor existing in the discharge cell collides with charged particles as well as vacuum ultraviolet rays, the surface of the phosphor is degraded temporarily or permanently. This may result in the generation of image sticking. However, since the white image and the black image are alternately displayed according to one embodiment, the surface of the phosphor existing in all the discharge cells of the plasma display panel 100 is even such that the image sticking is removed.

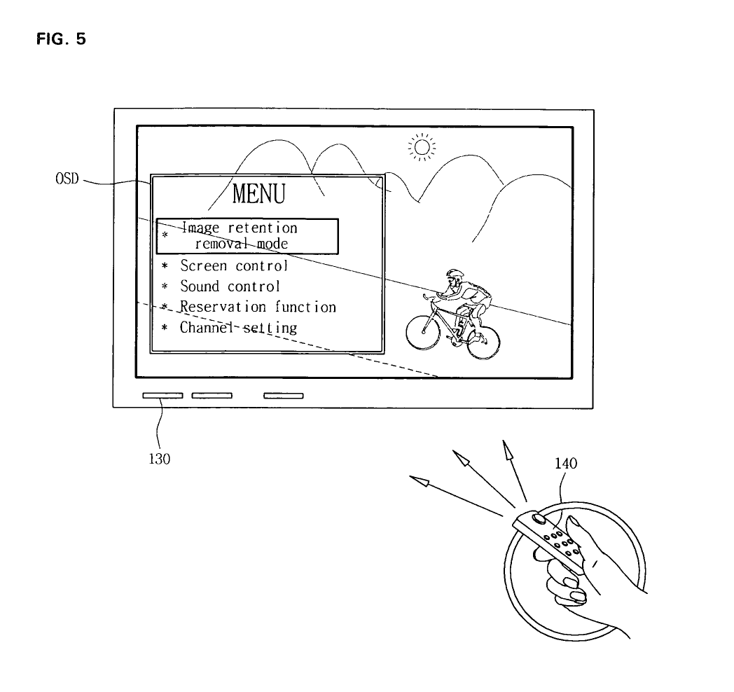

The memory 150 may store on-screen display (OSD) data for removing the image sticking. In a case where the controller 120 controls the driver 110 in response to the OSD data stored in the memory 150, the plasma display apparatus according to one embodiment displays an OSD of FIG. 5. If the user selects an image sticking removal mode, the key signal generator 130 or the remote controller 140 of FIG. 1 outputs the image sticking removal mode signal to the controller 120. Accordingly, the plasma display apparatus according to one embodiment performs an image sticking removal operation as illustrated in FIG. 2.

In FIG. 5, after the plasma display apparatus displayed the OSD, the user selected the image sticking removal mode such that the key signal generator 130 or the remote controller 140 output the image sticking removal mode signal. However, the user operates the key signal generator 130 or the remote controller 140 for selecting the image sticking removal mode without the display of the OSD, and thus the plasma display apparatus according to one embodiment can perform the image sticking removal operation.

After the controller 120 receives APLs of the nth and (n+1)th frames from the APL calculator 160, the controller 120 calculates a difference between the APLs of the nth and (n+1)th frames. When the difference between the APLs of the nth and (n+1)th frames is more than a threshold value, the controller 120 causes the driver 110 to supply the first data pulse of a high or low level to the address electrodes X1-Xm during the first period, and to supply the second data pulse of a level different from the level of the first data pulse to the address electrodes X1-Xm during the second period.

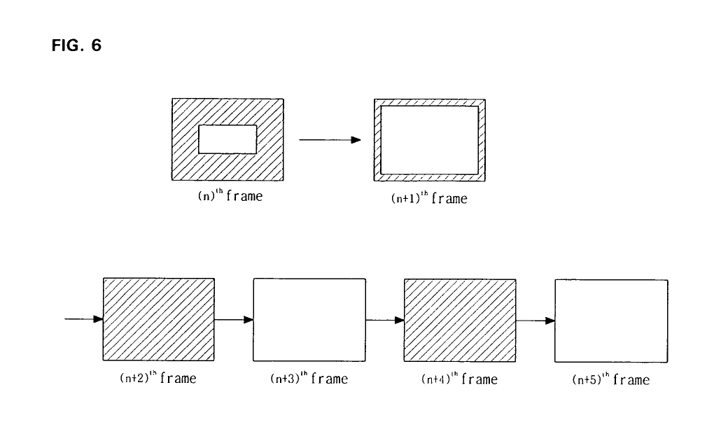

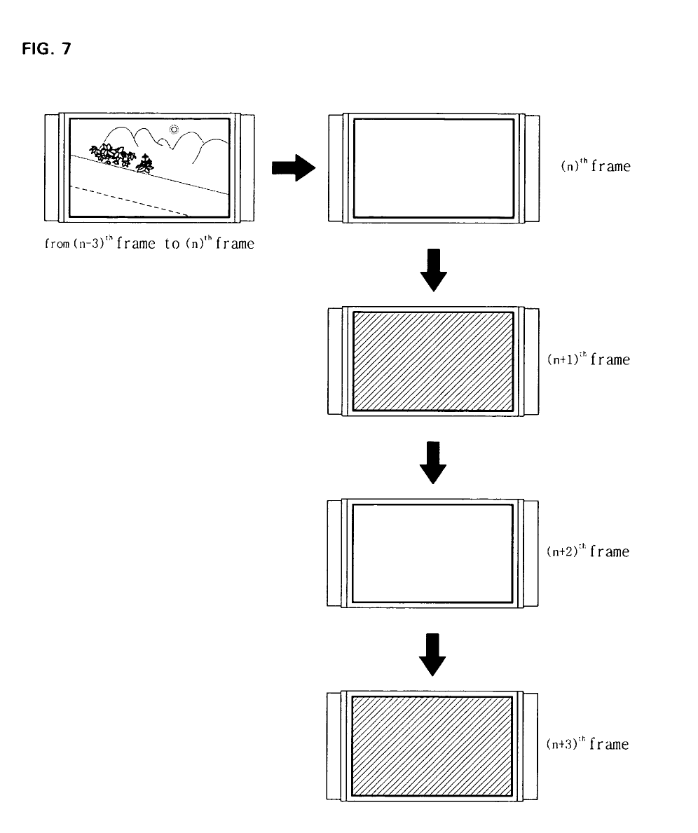

For example, as illustrated in FIG. 6, when the difference between the APLs of the nth and (n+1)th frames is more than the threshold value, the driver 110 supplies the first data pulse of the low level to the address electrodes X1-Xm during (n+2)th and (n+4)th frames, and supplies the second data pulse of the high level to the address electrodes X1-Xm during (n+3)th and (n+5)th frames.

When the same image is displayed on the plasma display panel 100 for a limited period of time, the plasma display apparatus according to one embodiment performs an image sticking operation. For example, in a case where the limited period of time is equal to 3 frames and a specific image is displayed during the (n−3)th to nth frames, the controller 120 compares the limited period of time and image display time. Since the image display time (i.e., 4 frames) is more than the limited period of time (i.e., 3 frames), the driver 110 supplies the first data pulse of the high level to the address electrodes X1-Xm during the first period (i.e., during the (n+1)th and (n+3)th frames), and supplies the second data pulse of the low level to the address electrodes X1-Xm during the second period (i.e., during the (n+2)th and (n+4)th frames).

As above, the driver 110 supplies the pulse for erasing the wall charges formed on the scan electrodes Y1-Yn and the sustain electrodes Z1-Zn to at least one of the scan electrodes Y1-Yn, the sustain electrodes Z1-Zn, or the address electrodes X1-Xm.

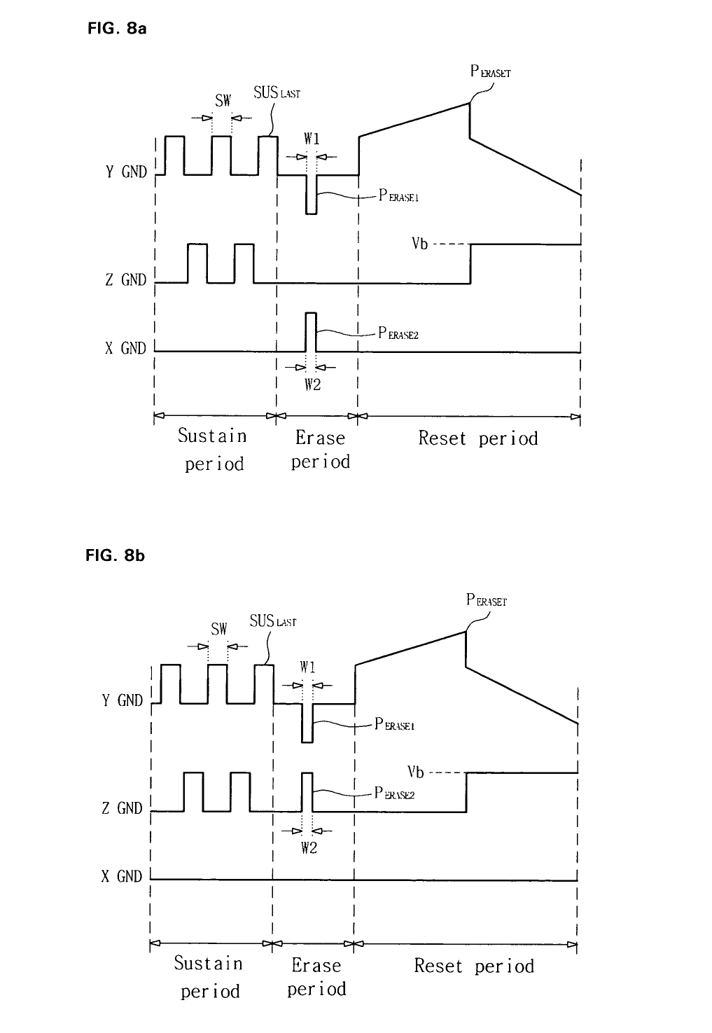

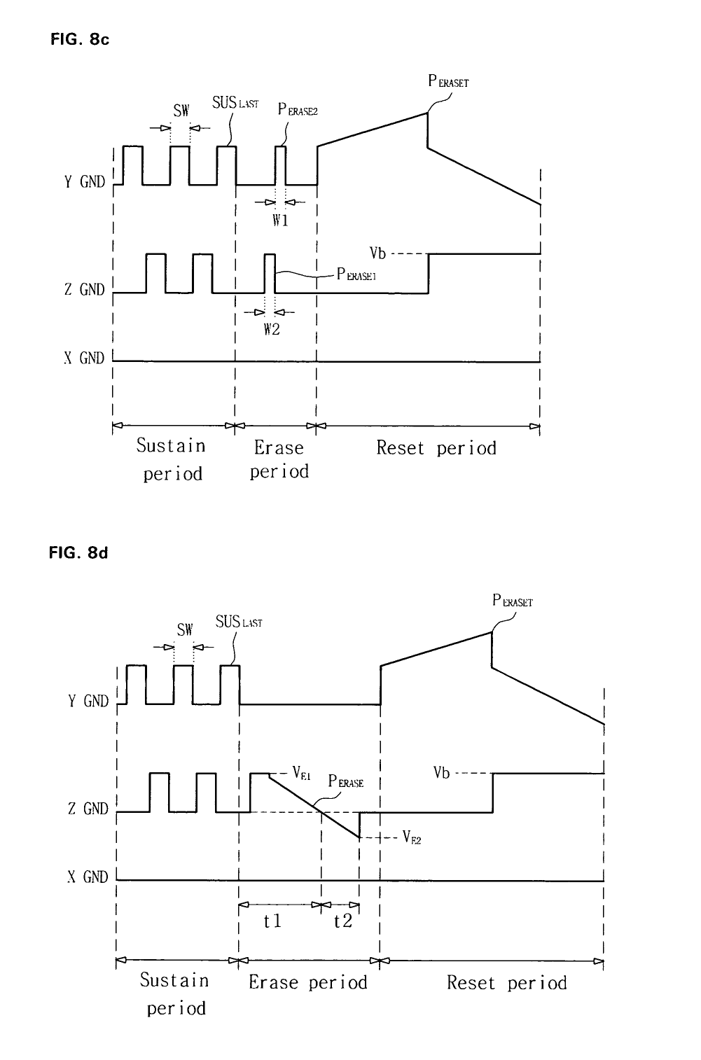

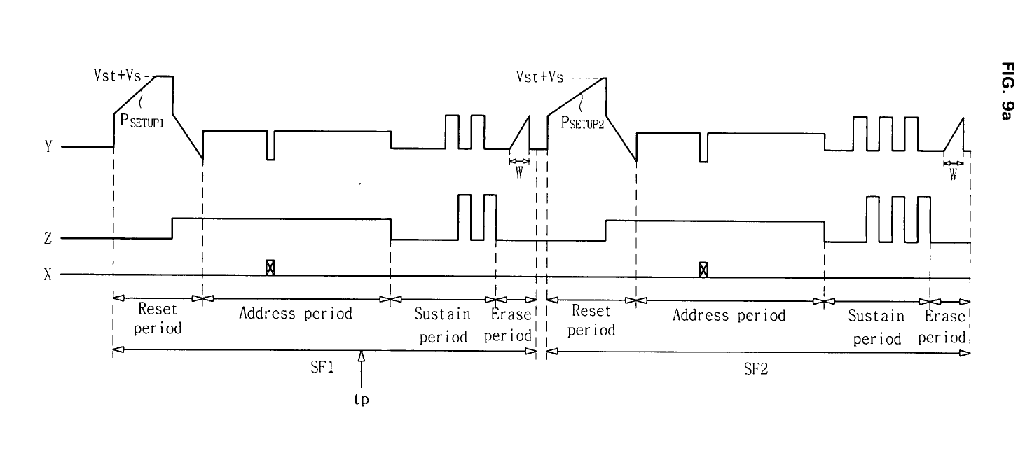

As illustrated in FIG. 8a, the driver 110 may supply a last sustain pulse (SUS_{LAST}) of a first polarity to the scan electrode Y during the sustain period. Then, the driver 110 may supply a first pulse (P_{ERASE1}) of a second polarity different from the first polarity and a second pulse (P_{ERASE2}) of the first polarity to the scan electrode Y and the address electrode X, respectively.

For example, the driver 110 supplies a last sustain pulse (SUS_{LAST}) of a positive polarity to the scan electrode Y during the sustain period. Then, the driver 110 supplies a first pulse (P_{ERASE1}) of a negative polarity and a second pulse (P_{ERASE2}) of a positive polarity to the scan electrode Y and the address electrode X, respectively. Afterwards, the driver 110 supplies a reset pulse (PRESET) and a bias voltage Vb to the scan electrode Y and the sustain electrode Z during the reset period.

In present embodiment, the highest voltage level of the positive polarity pulse is higher than a ground level voltage GND, and the lowest voltage level of the negative polarity pulse is lower than the ground level voltage GND. For example, the highest voltage level of the second pulse (P_{ERASE2}) of the positive polarity pulse is higher than the ground level voltage GND.

In present embodiment, a width SW of a sustain pulse may be more than a width W1 of the first pulse (P_{ERASE1}) and a width W2 of the second pulse (P_{ERASE2}). The width W1 of the first pulse (P_{ERASE1}) may be substantially equal to the width W2 of the second pulse (P_{ERASE2}). Since the widths W1 and W2 of the first and second pulses (P_{ERASE1}, P_{ERASE2}) are less than the width SW of the sustain pulse, the first and second pulses (P_{ERASE1}, P_{ERASE2}) generate an erase discharge. This results in an erasure of wall charges accumulated on the scan electrode Y, the sustain electrode Z, and the address electrode X. If wall charges are excessively accumulated on the scan electrode Y, the sustain electrode Z, and the address electrode X after the ending of the sustain period, the remaining wall charges in all the discharge cells is not uniform in spite of the supplying of a reset pulse. This may result in a cause of image sticking. However, according to one embodiment, the first and second pulses (P_{ERASE1}, P_{ERASE2}) erase the wall charges excessively accumulated on the scan electrode Y, the sustain electrode Z, and the address electrode X such that the remaining wall charges in all the discharge cells is uniform by the supplying of a reset pulse. Accordingly, image sticking is removed.

As illustrated in FIG. 8b, the driver 110 supplies a last sustain pulse (SUS_{LAST}) of a first polarity to the scan electrode Y during the sustain period. Then, the driver 110 supplies a first pulse (P_{ERASE1}) of a second polarity different from the first polarity and a second pulse (P_{ERASE2}) of the first polarity to the scan electrode Y and the sustain electrode Z, respectively. In present embodiment, a width SW of a sustain pulse may be more than a width W1 of the first pulse (P_{ERASE1}) and a width W2 of the second pulse (P_{ERASE2}). When the widths W1 and W2 of the first and second pulses (P_{ERASE1}, P_{ERASE2}) are less than the width SW of the sustain pulse, negative charges of the scan electrode Y and positive charges of the sustain electrode Z get out of a space of the discharge cell. Accordingly, wall charges on the scan electrode Y and the sustain electrode Z are erased such that image sticking is removed.

As illustrated in FIG. 8c, the driver 110 supplies a last sustain pulse (SUS_{LAST}) of a first polarity to the scan electrode Y during the sustain period. Then, the driver 110 supplies a first pulse (P_{ERASE1}) of the first polarity and a second pulse (P_{ERASE2}) of the first polarity to the scan electrode Y and the sustain electrode Z, respectively. In present embodiment, a width SW of a sustain pulse may be more than a width W1 of the first pulse (P_{ERASE1}) and a width W2 of the second pulse (P_{ERASE2}). When the widths W1 and W2 of the first and second pulses (P_{ERASE1}, P_{ERASE2}) are less than the width SW of the sustain pulse, negative charges of the scan electrode Y and positive charges of the sustain electrode Z get out of a space of the discharge cell. Accordingly, wall charges on the scan electrode Y and the sustain electrode Z are erased such that image sticking is removed.

As illustrated in FIG. 8d, the driver 110 supplies a last sustain pulse (SUS_{LAST}) of a first polarity to the scan electrode Y during the sustain period. Then, the driver 110 supplies a pulse (P_{ERASE}) gradually falling from a voltage (V_{E1}) of a first polarity to a voltage (V_{E2}) a second polarity different from the first polarity to the sustain electrode Z. When the last sustain pulse (SUS_{LAST}) of the first polarity is supplied to the scan electrode Y, negative charges are formed on the scan electrode Y and positive charges are formed on the sustain electrode Z. When the pulse (P_{ERASE}) is supplied to the sustain electrode Z during a period t1, the positive charges around the sustain electrode Z get out of the sustain electrode Z and the positive charges combine with the negative charges on the scan electrode Y. When the pulse (P_{ERASE}) is supplied to the sustain electrode Z during a period t2, the amount of positive charges got out of the sustain electrode Z decreases. Accordingly, the wall charges on the scan electrode Y and the sustain electrode Z are erased such that image sticking is removed.

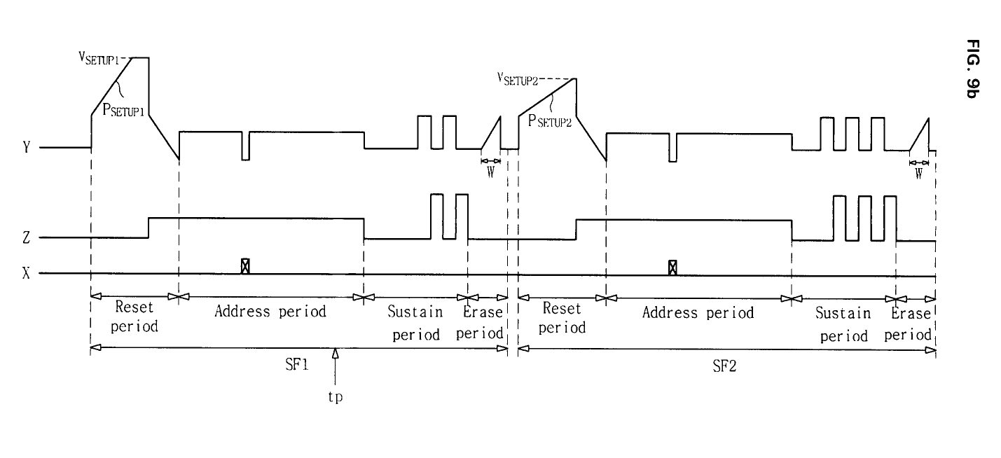

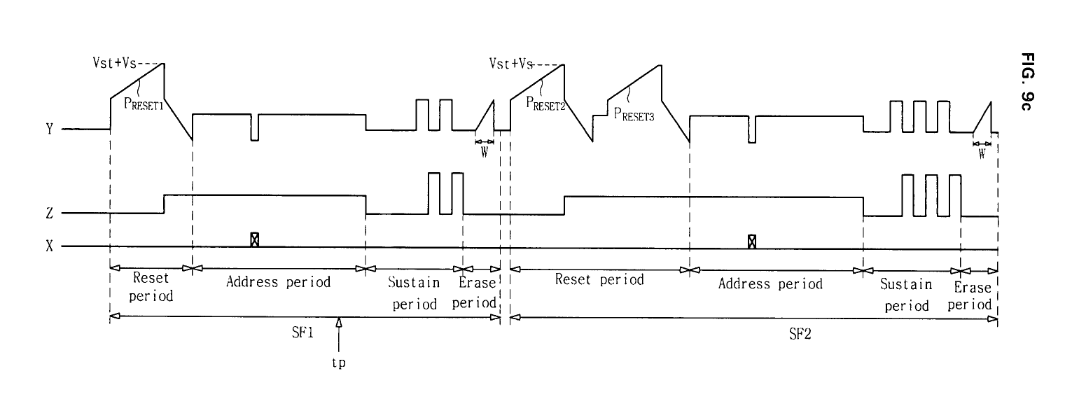

As illustrated in FIG. 9a, the driver 110 supplies a setup pulse with a rising slope, that is less than a rising slope of a setup pulse supplied during a reset period of a subfield, during a reset period of a next subfield, wherein the image sticking removal mode signal is input during the subfield. More specifically, a reference symbol tp indicates an input time point of the image sticking removal mode signal. In a case where the time point tp belongs to a subfield SF1, the driver 110 supplies a setup pulse (P_{SETUP2}) with a rising slope, that is less than a rising slope of a setup pulse (P_{SETUP1}) supplied during a reset period of the subfield SF1, during a reset period of a next subfield SF2 to the subfield SF1. The setup pulses (P_{SETUP1} and P_{SETUP2}) have a waveform gradually rising from a first voltage Vs to a second voltage (Vst+Vs). The rising slopes of the setup pulses (P_{SETUP1} and P_{SETUP2}) indicate a ratio of a difference between the first voltage Vs and the second voltage (Vst+Vs) to time required to raise from the first voltage Vs to the second voltage (Vst+Vs). Accordingly, since the amount of wall charges formed in the discharge cell in the subfield SF2 is less than the amount of wall charges formed in the discharge cell in the subfield SF1, image sticking is removed.

As illustrated in FIG. 9b, the driver 110 supplies a setup pulse with the highest voltage, that is lower than the highest voltage of a setup pulse supplied during a reset period of a subfield, during a reset period of a next subfield, wherein the image sticking removal mode signal is input during the subfield. More specifically, when an input time point tp of the image sticking removal mode signal belongs to a subfield SF1, the driver 110 supplies a setup pulse (P_{SETUP2}) with the highest voltage (V_{SETUP2}), that is lower than the highest voltage (V_{SETUP1}) of a setup pulse (P_{SETUP1}) supplied during a reset period of the subfield SF1, during a reset period of a next subfield SF2 to the subfield SF1. Accordingly, since the amount of wall charges formed in the discharge cell in the subfield SF2 is less than the amount of wall charges formed in the discharge cell in the subfield SF1, image sticking is removed.

As illustrated in FIG. 9c, the driver 110 supplies reset pulses, that is more than the number of reset pulses supplied during a reset period of a subfield, during a reset period of a next subfield, wherein the image sticking removal mode signal is input during the subfield. More specifically, when an input time point tp of the image sticking removal mode signal belongs to a subfield SF1, the driver 110 supplies setup pulses (P_{RESET2} and P_{RESET3}), that is more than the number of reset pulses (P_{RESET1}) supplied during a reset period of the subfield SF1, during a reset period of a next subfield SF2 to the subfield SF1. Accordingly, since the amount of wall charges formed in the discharge cell in the subfield SF2 is less than the amount of wall charges formed in the discharge cell in the subfield SF1, image sticking is removed.

As described above, when the plasma display apparatus according to one embodiment displays the OSD, the key signal generator 130 or the remote controller 140 of FIG. 1 outputs the image sticking removal mode signal to the controller 120 depending on the image sticking removal mode selection of the user. Accordingly, the plasma display apparatus according to one embodiment can be operated as illustrated in FIGS. 8a-8d and 9a-9c.

The foregoing embodiments and advantages are merely exemplary and are not to be construed as limiting the present invention. The present teaching can be readily applied to other types of apparatuses. The description of the foregoing embodiments is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures. Moreover, unless the term “means” is explicitly recited in a limitation of the claims, such limitation is not intended to be interpreted under 35 USC 112 (6).

What is claimed is:

1. A plasma display apparatus comprising:
a plasma display panel including a scan electrode, a sustain electrode, and an address electrode; and
a driver that supplies a first data pulse of either a high level or a low level to the address electrode during a first period, and supplies a second data pulse of either a high level or a low level to the address electrode during a second period, wherein the level of the first data pulse is different from the level of the second data pulse.

2. The plasma display apparatus of claim 1, wherein the driver supplies a pulse for erasing wall charges formed on the scan electrode and the sustain electrode to at least one of the scan electrode, the sustain electrode, or the address electrode.

3. The plasma display apparatus of claim 1, further comprising a controller controlling the driver to supply the first data pulse and the second data pulse when receiving an image sticking removal mode signal.

4. The plasma display apparatus of claim 3, the controller receives the image sticking removal mode signal from a remote controller or a key signal generator.

5. The plasma display apparatus of claim 1, wherein the first period is equal to an n-th frame, and the second period is equal to an (n+1)th frame.

6. The plasma display apparatus of claim 1, wherein the first period is equal to an n-th subfield, and the second period is equal to an (n+1)th subfield.

7. The plasma display apparatus of claim 1, wherein the driver supplies the first data pulse to emit light from all discharge cells of the plasma display panel, and
the driver supplies the second data pulse not to emit light from all the discharge cells of the plasma display panel.

8. The plasma display apparatus of claim 1, wherein the plasma display panel includes first and second scan electrodes adjacent to each other, a first discharge cell corresponding to the first scan electrode, and a second discharge cell corresponding to the second scan electrode,
the driver supplies the first data pulse to emit light from the first discharge cell and not to emit light from the second discharge cell, and
the driver supplies the second data pulse not to emit light from the first discharge cell and to emit light from the second discharge cell.

9. The plasma display apparatus of claim 1, wherein when a variation between an average picture level (APL) of a first frame and an APL of a second frame is more than a threshold value, the driver supplies the first data pulse to the address electrode during the first period, and supplies the second data pulse reverse to the first data pulse to the address electrode during the second period.

10. The plasma display apparatus of claim 1, wherein when the same image is displayed on the plasma display panel for a predetermined period of time, the driver supplies the first data pulse to the address electrode during the first period, and supplies the second data pulse reverse to the first data pulse to the address electrode during the second period.

11. A plasma display apparatus comprising:
a plasma display panel including a scan electrode, a sustain electrode, and an address electrode;
a controller that receives an image sticking removal mode signal; and
a driver that supplies a pulse for erasing wall charges formed on the scan electrode and the sustain electrode to at least one of the scan electrode, the sustain electrode, or the address electrode when the image sticking removal mode signal is input.

12. The plasma display apparatus of claim 11, further comprising at least one of a remote controller or a key signal generator that outputs the image sticking removal mode signal to the controller.

13. The plasma display apparatus of claim 11, wherein the driver supplies a last sustain pulse of a first polarity to the scan electrode during a sustain period, and
the driver supplies a first pulse of a second polarity different from the first polarity and a second pulse of the first polarity to the scan electrode and the address electrode during the sustain period, respectively.

14. The plasma display apparatus of claim 13, wherein a width of the last sustain pulse is more than a width of the first pulse and a width of the second pulse.

15. The plasma display apparatus of claim 11, wherein the driver supplies a last sustain pulse of a first polarity to the scan electrode during a sustain period, and
the driver supplies a first pulse of a second polarity different from the first polarity and a second pulse of the first polarity to the scan electrode and the sustain electrode during the sustain period, respectively.

16. The plasma display apparatus of claim 15, wherein a width of the last sustain pulse is more than a width of the first pulse and a width of the second pulse.

17. The plasma display apparatus of claim 11, wherein the driver supplies a last sustain pulse of a first polarity to the scan electrode during a sustain period, and
the driver supplies a first pulse of a second polarity different from the first polarity and a second pulse of the first polarity to the sustain electrode and the scan electrode during the sustain period, respectively.

18. The plasma display apparatus of claim 17, wherein a width of the last sustain pulse is more than a width of the first pulse and a width of the second pulse.

19. The plasma display apparatus of claim 11, wherein the driver supplies a last sustain pulse of a first polarity to the scan electrode during a sustain period, and
the driver supplies a pulse gradually falling from a voltage of the first polarity to a voltage of a second polarity different from the first polarity to the sustain electrode during the sustain period.

20. The plasma display apparatus of claim 11, wherein the driver supplies a setup pulse with a rising slope, that is less than a rising slope of a setup pulse supplied during a reset period of a subfield, during a reset period of a next subfield,
wherein the image sticking removal mode signal is input during the subfield.

21. The plasma display apparatus of claim 11, wherein the driver supplies a setup pulse with the highest voltage, that is lower than the highest voltage of a setup pulse supplied during a reset period of a subfield, during a reset period of a next subfield,
wherein the image sticking removal mode signal is input during the subfield.

22. The plasma display apparatus of claim 11, wherein the driver supplies reset pulses, that is more than the number of reset pulses supplied during a reset period of a subfield, during a reset period of a next subfield,
wherein the image sticking removal mode signal is input during the subfield.
